(19) United States
(12) Patent Application Publication
(10) Pub. No.: US 2020/0183106 A1
(43) Pub. Date: Jun. 11, 2020

(54) PLUGGABLE OPTICAL TRANSCEIVER MODULE

(71) Applicant: Adolite, Inc., Santa Clara, CA (US)

(72) Inventors: Yeh Chun LUN, Hsinchu City (TW); Lin Pin RU, Taoyuan City (TW); Lin Sheng FU, Hsinchu County (TW)

(21) Appl. No.: 16/528,327

(22) Filed: Jul. 31, 2019

(30) Foreign Application Priority Data
Dec. 6, 2018 (TW) 107143805

(51) Int. Cl. G02B 6/42; H01R 13/629; H01R 13/627

(52) U.S. Cl. CPC G02B 6/4261; H01R 13/6275; H01R 13/62911; G02B 6/4278

(57) ABSTRACT

A pluggable optical transceiver module for inserting into a socket slot includes a body, a moving member and at least one elastic member. The body includes a head portion, an inserting portion to the slot, two sides, two sliding slots and at least one first limiting slot. The two sliding slots are respectively disposed on two sides. The first limiting slot is disposed in one of the sliding slots. The moving member includes a connecting arm and two extending arms and is detachably disposed on the body. Each extending arm includes a second fastening portion, a first limiting portion, and an elastic member insertion hole. When the moving member is disposed on the body, the two extending arms respectively move in the two sliding slots, and the first limiting portion moves in the first limiting slot. The elastic member is in the first limiting slot via the insertion hole.

### CROSS REFERENCES TO RELATED APPLICATIONS

This application claims the benefits of priority to Patent Application No. 107143805, entitled “PLUGGABLE OPTICAL TRANSCEIVER MODULE”, filed with Taiwan IP Office on Dec. 6, 2018, the contents of which are incorporated herein by reference in its entirety.

### TECHNICAL FIELD

The present disclosure relates to the field of optical communication, and more particularly to a detachable pluggable optical transceiver module.

### BACKGROUND

Optical transceiver module is generally provided in the modern high-speed communication network. The optical transceiver module is usually installed in an electronic communication device. In order to increase the flexibility of the system design and the maintenance convenience, the optical transceiver module is inserted into the socket of the communication device in a pluggable manner. In general, the socket is disposed on the circuit board. In order to define the electrical and mechanical interface between the optical transceiver module and the corresponding socket, various standards have been proposed, such as the XFP standard and the QSFP (quad small form-factor pluggable) standard.

The corresponding socket of the optical transceiver module is generally provided with a latching mechanism, so that the optical transceiver module can be fixed in the socket when inserted. Moreover, the optical transceiver module is provided with a disengagement mechanism to release the fixing of the latching mechanism, so that the optical transceiver module can be detached from the socket. However, the disengagement mechanism is prone to damage when it is inserted and removed multiple times.

Therefore, how to conveniently and quickly repair the disengagement mechanism of the optical transceiver module is a focus of attention of relevant personnel in the field. Based on the above, it is necessary to provide an optical module to meet the present requirements.

### SUMMARY

The invention provides a pluggable optical transceiver module, which has a slider can be quickly and easily disassembled and assembled without damage to the optical interface.

Other objects and advantages of the present invention will become apparent from the technical features disclosed herein. In order to achieve one or a part or all of the above or other objects, an embodiment of the present invention provides a pluggable optical transceiver module for being inserted into a slot of a socket. The socket includes two first engaging portions, and the first engaging portion is located in the slot. The pluggable optical transceiver module includes a body having a first end surface and a second end surface, wherein the first end surface is opposite to the second end surface, wherein an optical interface is disposed at the first end surface and an electrical interface is disposed at the second end surface, for converting optical signals to electrical signals, a slider and at least one elastic member. The body is for being inserted into the slot. The body includes a head portion, an insertion portion, two side surfaces, two sliding slots, and at least one first limiting slot. The insertion portion is for being inserted into the socket. The head portion is connected to the insertion portion. The two side surfaces are opposite to each other. The two side surfaces are respectively located on opposite sides of the head portion and the insertion portion. The two sliding slots are respectively disposed on the two side surfaces. The first limiting slot is disposed in one of the sliding slots. The first limiting slot includes a first limiting surface and a second limiting surface. The first limiting surface is closer to an end point of the head portion away from the insertion portion than the second limiting surface. The slider is detachably disposed on the body. The slider includes a connecting arm and two extending arms. The connecting arm is connected between the two extending arms. Each of the extending arms includes a second engaging portion, a first limiting portion, and an elastic member insertion hole. When the slider is disposed on the body, the body is located between the two extending arms, the two extending arms respectively move in the two sliding slots, and the first limiting portion moves in the first limiting slot. The elastic member is disposed in the first limiting slot, and the elastic member is located between the first limiting surface and the first limiting portion of the slider. The elastic member insertion hole is for inserting the elastic member into the first limiting slot, so that the elastic member is located between the first limiting surface and the first limiting portion.

In an embodiment of the invention, when the slider is disposed on the body and the body is inserted into the slot, each of the extending arms is moved between an engaging portion and a releasing position in each of the sliding slots. When the two extending arms are in the engaging position, the two second engaging portions are engaged on the two first engaging portions. When the two extending arms are in the releasing position, the two second engaging portions push against the two first engaging portions, so that the two first engaging portions are relatively far apart.

In an embodiment of the invention, the extending arm further includes a latching member. The latching member is connected to the second engaging portion. The body further includes a latching slot hole. The latching slot hole corresponds to the latching member. The latching member is located in the latching slot hole when the extending arm is in the engaging position.

In an embodiment of the invention, the latching slot hole includes a latching surface. The latching surface faces an inner side of the body. The latching member is adjacent to the latching surface when the latching member is located in the latching slot hole.

In an embodiment of the invention, the body further includes an extension structure. The extension structure extends from the side surface to an inside of the body, and the extension structure extends from an outside of the sliding slot to an inside of the sliding slot. The extension structure partially shields the extending arm when the extending arm is in the engaging position, such that a portion of the extending arm is not exposed to the body.

In an embodiment of the invention, the pluggable optical transceiver module includes two elastic members. The body includes the two first limiting slots. The two first limiting slots are respectively disposed in the two sliding slots. The two elastic members are respectively disposed in the two first limiting slots when the slider is disposed on the body.

In an embodiment of the invention, the body further includes two second limiting slots. The two second limiting slots are respectively disposed in the two sliding slots. The second limiting slot is adjacent to an end point of the sliding slot on a side of the head portion. Each of the extending arms further includes a second limiting portion. The elastic member insertion hole is located between the first limiting portion and the second limiting portion. Wherein, the second limiting portion moves in the second limiting slot when the slider is disposed on the body.

In an embodiment of the invention, the second limiting slot includes a third limiting surface and a fourth limiting surface. The third limiting surface is closer to an end point of the head portion away from the insertion portion than the fourth limiting surface. Wherein, the second limiting portion moves relative to the extending arm between a coupling position and a separating position. The second limiting portion is located at the coupling position when the second limiting portion is not affected by an external force. The second limiting portion is pushed by the external force to move toward an outside of the slider to the separating position. When the slider is disposed on the body and the second limiting portion is in the coupling position, the second limiting portion is moved between the third limiting surface and the fourth limiting surface of the second limiting slot. The second limiting portion is blocked by the third limiting surface, so that the second limiting portion cannot be separated from the second limiting slot. When the second limiting portion is pushed by the external force to move toward an outside of the slider to the separating position, the second limiting portion is not blocked by the third limiting surface, so that the second limiting portion can be separated from the second limiting slot and the slider is separated from the body.

In an embodiment of the invention, the body further includes two detaching holes, a first end surface and a second end surface. The first end surface is opposite to the second end surface. The two side surfaces are respectively connected to the first end surface and the second end surface. The first end surface is located at one end side of the head portion wherein an optical fiber cable is connected to the optical interface to provide light into the optical transceiver module. The second end surface is located at one end side of the insertion portion wherein the electrical interface is connected to the slot. The detaching hole penetrates from the first end surface to the third limiting surface, so that a detaching member penetrates the detaching hole to give the external force to the second limiting portion.

In an embodiment of the invention, the pluggable optical transceiver module further includes a handle pivotally disposed on the connecting arm of the slider.

In an embodiment of the invention, the handle includes a handle body. The handle body includes a long axis. The two extending arms respectively move in the two sliding slots along a moving axis when the slider is disposed on the body. An angle between the long axis and the moving axis is between 0-180 degrees when the handle rotates relative to the slider.

The pluggable optical transceiver module of the embodiment of the present invention includes a slider that can be easily and quickly disassembled and assembled. When the slider and/or the handle are damaged, it can be replaced quickly and easily. The handle of the optical transceiver module of the present invention can be pivoted relative to the body between 0-180 degrees, so that components such as fiber optic lines can be easily connected with the optical transceiver module, and the optical transceiver module can be conveniently stored.

The above and other objects, features and advantages of the present invention will become more apparent by the following preferred embodiments and figures.

### BRIEF DESCRIPTION OF THE DRAWINGS

FIGS. 1A to 1C are schematic views of a pluggable optical transceiver module according to an embodiment of the present disclosure.

FIGS. 2A to 2B are schematic views showing two positions of the slider of the pluggable optical transceiver module in operation, according to an embodiment of the present disclosure.

FIGS. 3A to 3C are schematic views of a pluggable optical transceiver module according to an embodiment of the present invention.

FIGS. 4A to 4B are partial schematic views of a pluggable optical transceiver module according to an embodiment of the present invention.

FIGS. 5A to 5B are schematic views showing the operation of a handle of a pluggable optical transceiver module according to an embodiment of the present invention.

FIG. 6A is a schematic view of a slider of a pluggable optical transceiver module according to another embodiment of the present invention.

FIG. 6B and FIG. 6C are partial schematic views showing a pluggable optical transceiver module partially inserted into a socket according to another embodiment of the present invention.

FIG. 7 is a partial schematic view showing a pluggable optical transceiver module partially inserted into a socket according to another embodiment of the present invention.

### DETAILED DESCRIPTION OF THE PREFERRED EMBODIMENTS

Implementations of the present disclosure are illustrated below through specific embodiments. Those skilled in the art can easily understand other advantages and efficacy of the present disclosure according to the content disclosed in this specification. The present disclosure can also be implemented or applied through other different specific implementations. Various modifications or variations can also be made on details in this specification based on different opinions and applications without departing from the spirit of the present disclosure.

It should be noted that, the figures provided in this embodiment merely illustrate the basic conception of the present disclosure schematically. Therefore, the figures only show components related to the present disclosure, and are not drawn according to the quantity, shapes and sizes of components during actual implementation. The pattern, quantity and ratio of components during actual implementation can be changed arbitrarily, and the component layout may also be more complex.

The above and other technical contents, features and advantages of the present invention will be apparent from the following detailed description of the preferred embodiments. The directional terms mentioned in the following embodiments, such as up, down, left, right, front or back, etc., are only directions referring to the additional drawings. Therefore, the directional terminology used is used to illustrate but not intended to limit the invention.

Following is the descriptions of the list of symbols used in the drawings

### SYMBOL DESCRIPTIONS

10, 10a, 10b: pluggable optical transceiver module
11, 11a, 11b: body
111: head portion
1111: first end surface
1113: optical interface
112, 112a: side surface
113: insertion portion
1131: second end surface
1133: electrical interface
114, 114a: sliding slot
115, 115a: first limiting slot
1151: first limiting surface
1153: second limiting surface
116, 116a: second limiting slot
1161: third limiting surface
1163: fourth limiting surface
1165, 1165a: detaching hole
117b, 117c: latching slot hole
1171b, 1171c: latching surface
119: extension structure
12, 12a: elastic member
13, 13a, 13b: sliding member
131: connecting arm
132, 132a, 132b, 132c: extending arm
1321, 1321a: second engaging portion
1322b, 1322c: latching member
1323, 1323a: first limiting portion
1325, 1325a: second limiting portion
135: moving axis
1327: elastic member insertion hole
15: handle
151: pivot
153: handle body
155: long axis
16: detaching member
A1: engaging position
A2: releasing position
B1: coupling position
B2: separating position
E: area
F1: pulling force
F2: external force
S: socket
S1: slot
S21, S21a: first engaging portion
S3: electronic contact

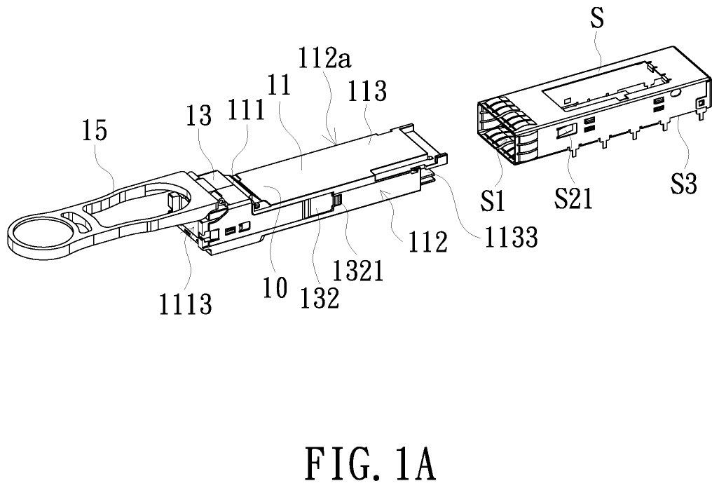

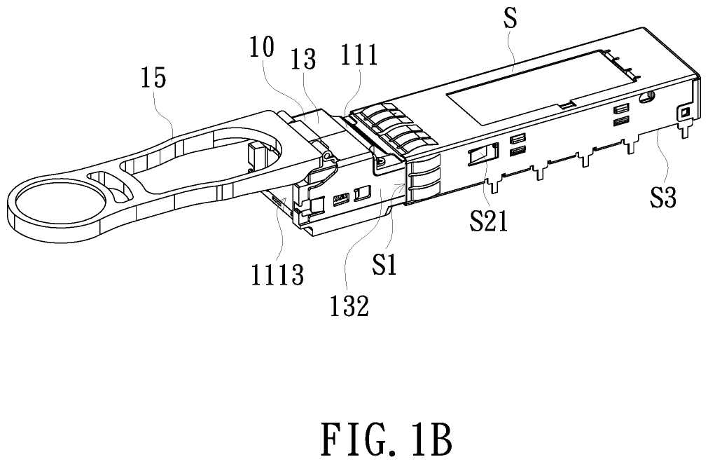

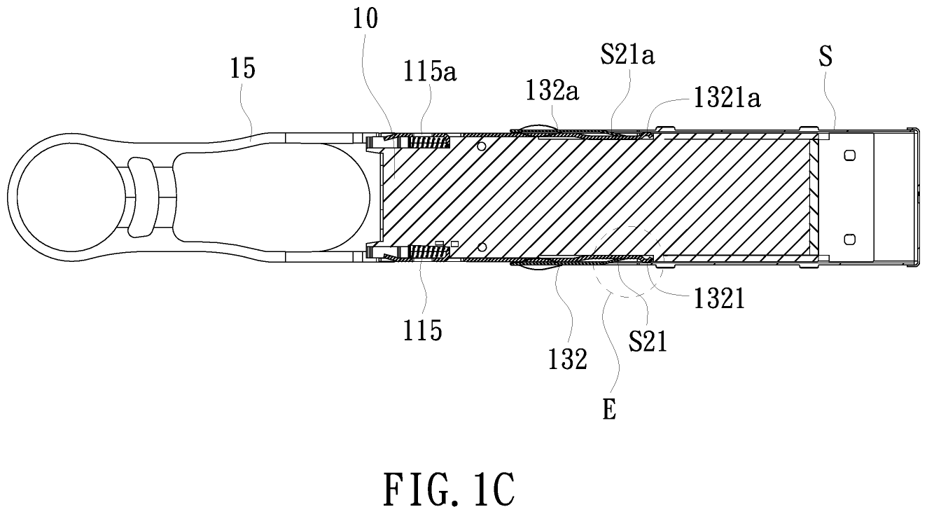

FIGS. 1A to 1C are schematic views of a pluggable optical transceiver module according to an embodiment of the present invention. Specifically, FIG. 1A is a schematic view of the pluggable optical transceiver module 10 separated from a socket S; FIG. 1B is a schematic view of the pluggable optical transceiver module 10 inserted into the socket S; and FIG. 1C is a schematic top cross-sectional view of the pluggable optical transceiver module 10 inserted into the socket S. Referring to FIG. 1A, the pluggable optical transceiver module 10 includes a body 11, a slider 13 and a handle 15, and the socket S includes a slot S1.

Referring to FIG. 1B, the pluggable optical transceiver module 10 is used to be inserted into the slot S1 of the socket S. The socket S may include, for example, an electronic contact S3, and the electronic contact S3 can be electrically connected to other electronic devices (not shown). The pluggable optical transceiver module 10 may include, for example, an optical interface 1113 and an electrical interface 1133. The optical interface 1113 may be, for example, connected to a component such as an optical fiber cable (not shown), but the invention is not limited thereto. The electrical interface 1133 of the pluggable optical transceiver module 10 can be electrically connected to the socket S when the pluggable optical transceiver module 10 is inserted into the slot S1 of the socket S. The pluggable optical transceiver module 10 may be provided with, for example, an optical/electrical conversion element (not shown). Therefore, the optical signal input by the optical interface 1113 can be converted into an electrical signal via the optical/electrical conversion element of the pluggable optical transceiver module 10, and the electrical signal can be transmitted to the socket S and then transmitted to the other electronic devices through the electronic contact S3. The electrical signals generated by other electronic devices can be transmitted to the pluggable optical transceiver module 10 through the electronic contact S3, and the optical/electrical conversion element of the pluggable optical transceiver module 10 can convert the electrical signals into optical signals and output the optical signals to an element such as an optical fiber cable through the optical interface 1113. Therefore, the object of optical signal transmission can be easily achieved through the arrangement of the pluggable optical transceiver module 10 and the socket S. Since the pluggable optical transceiver module 10 is pluggable and disposed on the socket S, a component such as an optical fiber cable can be easily connected to the electronic device provided with the socket S. The optical interface 1113, the electrical interface 1133, and the electronic contact S3 shown in FIGS. 1A and 1B are merely illustrative and are not intended to limit the invention.

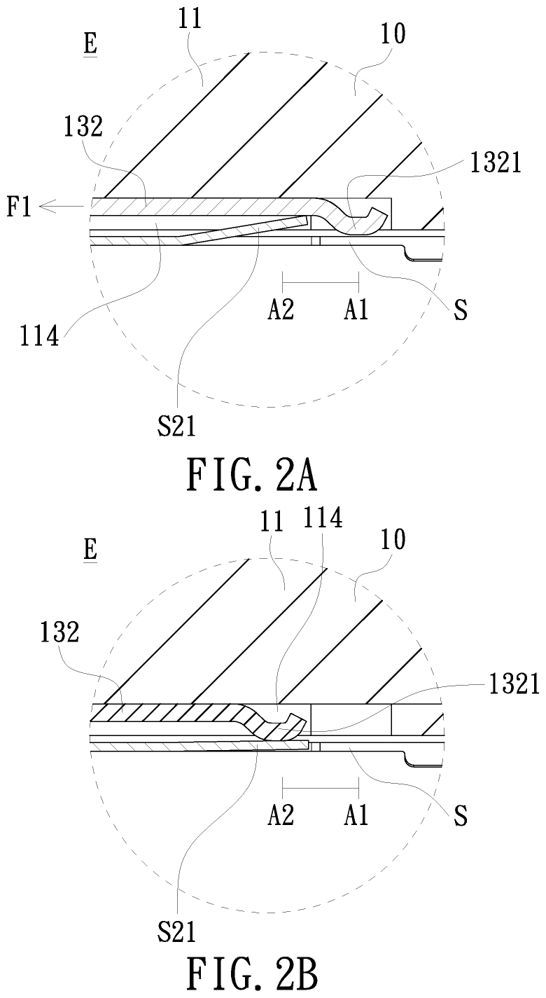

The handle 15 can be pulled by the user when the pluggable optical transceiver module 10 is inserted into the slot S1 of the socket S. When the handle 15 is pulled, the slider 13 of the pluggable optical transceiver module 10 can be moved relative to the body 11 to release the latch with the socket S and separate the pluggable optical transceiver module 10 from the socket S. The slider 13 of the pluggable optical transceiver module 10 of the present embodiment can be separated or combined with the body 11 conveniently and quickly. Therefore, the new slider 13 can quickly replace the old slider 13 when the slider 13 and/or the handle 15 are damaged by being repeatedly inserted and removed. As such, there is no need to disassemble the body 11 of the pluggable optical transceiver module 10 including the optical/electrical conversion element due to damage of the slider 13 and/or the handle 15, which can greatly reduce the maintenance cost and improve the maintenance efficiency. FIGS. 2A to 2B are schematic views showing the operation of the slider of the pluggable optical transceiver module according to an embodiment of the present invention. Specifically, FIGS. 2A to 2B are schematic views showing the area E shown in FIG. 1C, which shows the details of the operation when the slider 13 is moved relative to the body 11 to release the latch with the socket S. The specific operational details will be described in detail below.

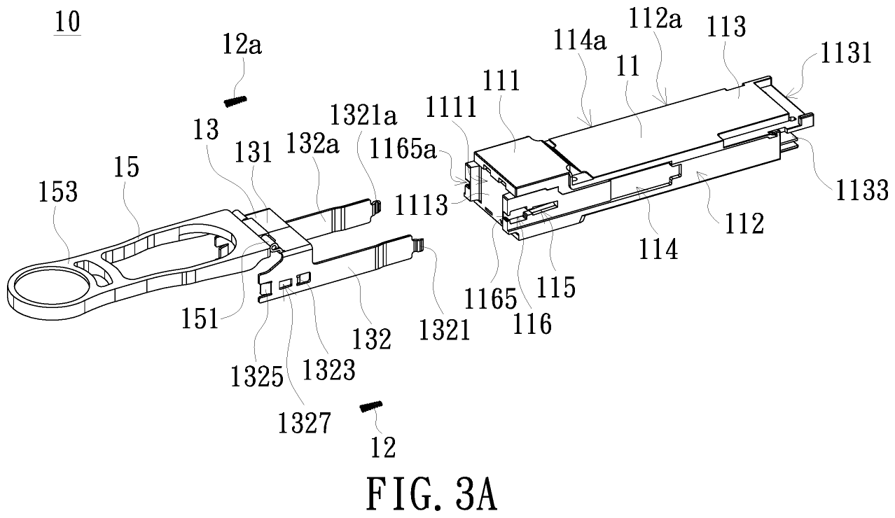

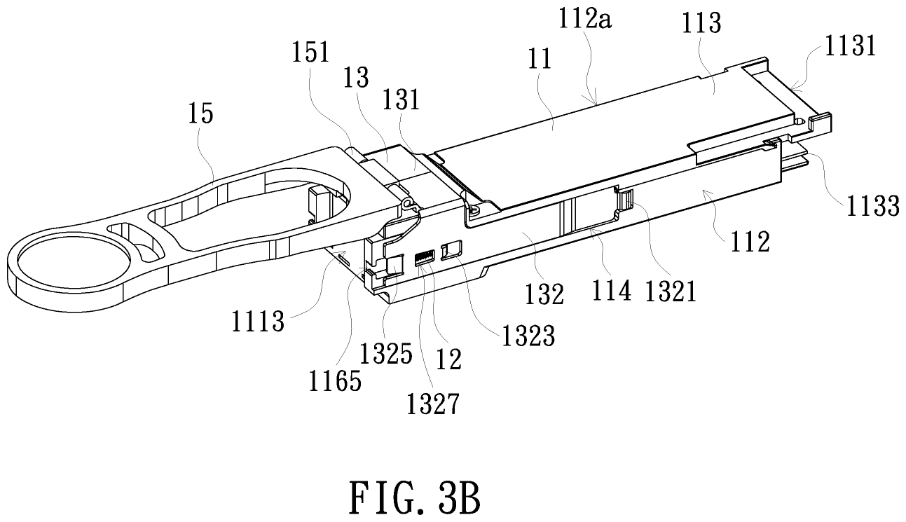

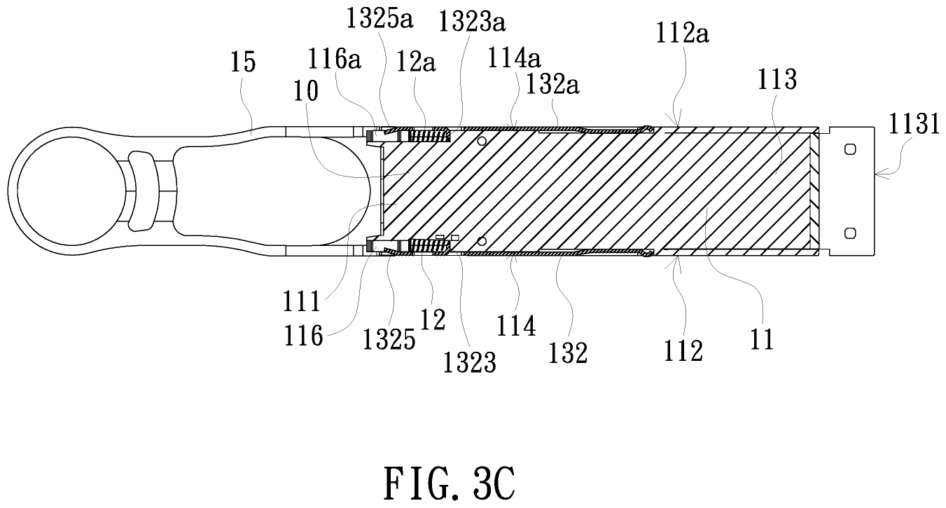

FIGS. 3A to 3C are schematic views of the pluggable optical transceiver module 10 of the embodiment shown in FIGS. 1A to 2B. Specifically, FIG. 3A is a schematic view showing the body 11 is separated from the slider 13; FIG. 3B is a schematic view showing the body 11 is combined with the slider 13; and FIG. 3C is a schematic top cross-sectional view showing the body 11 is combined with the slider 13. Specifically, FIGS. 1C and 3C are schematic top cross-sectional views of the plane where the first limiting slot 115 of the body 11 is located. Referring to FIG. 3A, the pluggable optical transceiver module 10 is used to be inserted into the slot S1 of the socket S of the embodiment shown in FIGS. 1A to 2B. As shown in FIG. 1C, the socket S includes two first engaging portions S21, S21a, and the first engaging portions S21, S21a are located in the slot S1.

The pluggable optical transceiver module 10 includes a body 11, a slider 13, and elastic members 12, 12a. The body 11 is used to be inserted into the slot S1. The body 11 includes a head portion 111, an insertion portion 113, two side surfaces 112, 112a, two sliding slots 114, 114a, and a first limiting slot 115. The insertion portion 113 is used to be inserted into the socket S. The head portion 111 is connected to the insertion portion 113. The two side surfaces 112, 112a are opposite to each other and are respectively located on opposite sides of the head portion 111 and the insertion portion 113. The two sliding slots 114, 114a are respectively disposed on the two side surfaces 112, 112a. The first limiting slot 115 is disposed in the sliding slot 114.

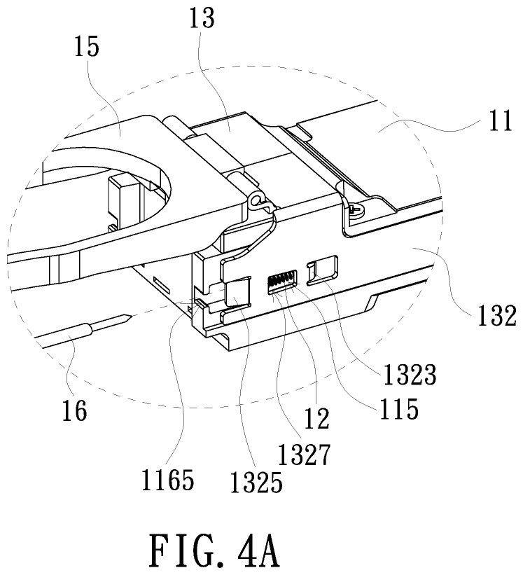

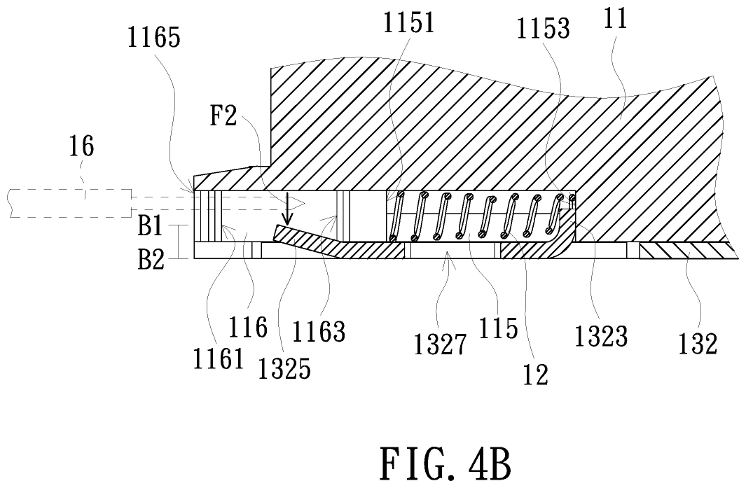

Please refer to FIGS. 4A to 4B. FIGS. 4A to 4B are schematic views of parts of the pluggable optical transceiver module 10 shown in FIGS. 3A to 3B. Specifically, FIG. 4A is a partial schematic view showing that the body 11 and the slider 13 are combined at the first limiting slot 115; and FIG. 4B is a partial top cross-sectional view showing that the body 11 and the slider 13 are combined at the first limiting slot 115. As shown in FIG. 4B, the first limiting slot 115 includes a first limiting surface 1151 and a second limiting surface 1153. The first limiting surface 1151 is closer to the end point of the head portion 111 away from the insertion portion 113 than the second limiting surface 1153. The slider 13 is detachably disposed on the body 11. As shown in FIG. 3A, the slider 13 includes a connecting arm 131 and two extending arms 132, 132a. The connecting arm 131 is connected between the two extending arms 132, 132a. The extending arm 132 includes a second engaging portion 1321, a first limiting portion 1323, and an elastic member insertion hole 1327.

As shown in FIG. 3B, the body 11 is located between the two extending arms 132, 132a of the slider 13 when the slider 13 is disposed on the body 11. The two extending arms 132, 132a are respectively moved in the two sliding slots 114, 114a, and the first limiting portion 1323 is moved in the first limiting slot 115. As shown in FIG. 4B, the elastic member 12 is disposed in the first limiting slot 115, and the elastic member 12 is located between the first limiting surface 1151 and the first limiting portion 1323 of the slider 13. Therefore, when the handle 15 is pulled, one end of the elastic member 12 abuts against the first limiting surface 1151, and the first limiting portion 1323 of the extending arm 132 compresses the elastic member 12. Therefore, as shown in FIGS. 2A to 2B, the slider 13 can be driven to move from the engaging position A1 to the releasing position A2 by pulling the handle 15. The slider 13 is moved to the engaging position A1 by the restoring force of the elastic member 12 when the handle 15 is not pulled.

Refer to FIGS. 2A to 2B again. FIGS. 2A and 2B are schematic top cross-sectional views of the first engaging portion S21 when the pluggable optical transceiver module 10 is inserted into the socket S. As shown in FIG. 2A, the slider 13 is moved to the engaging position A1 by the elastic restoring force of the elastic member 12 when the user does not pull the handle 15. At this time, the first engaging portion S21 of the socket S can abut against the second engaging portion 1321 of the extending arm 132 to fix the pluggable optical transceiver module 10 to the socket S to prevent falling off. The slider 13 can be given a pulling force F1 when the user pulls the handle 15. At this time, as shown in FIG. 2B, the slider 13 can be driven to move relative to the body 11 from the engaging position A1 to the releasing position A2 when the handle 15 is pulled. The second engaging portion 1321 of the extending arm 132 can abut against and release the latch with the first engaging portion S21, so that the pluggable optical transceiver module 10 can continue to move in the direction of the pulling force F1 and can be separated from the socket S.

The first engaging portions S21, S21a of the socket S may be, for example, a structure in which the socket S extends toward the inner side of the socket S, but the invention is not limited thereto. When the slider 13 is moved from the engaging position A1 to the releasing position A2, the second engaging portion 1321 of the extending arm 132 can abut against the first engaging portion S21 to move the first engaging portion S21 toward the outside of the socket S (as shown in FIG. 2B), so as to release the latch of the second engaging portion 1321 with the first engaging portion S21. FIGS. 2A and 2B only describe the operations of the first engaging portion S21 and the second engaging portion 1321. The operations of the first engaging portion S21a and the second engaging portion 1321a are similar to the operations of the first engaging portion S21 and the second engaging portion 1321, and no redundant detail is to be given herein.

Therefore, as shown in FIG. 1C, the extending arms 132, 132a are respectively moved between the engaging position A1 and the releasing position A2 in the sliding slots 114, 114a when the slider 13 is disposed on the body 11 and the body 11 is inserted into the slot S. The two second engaging portions 1321, 1321a are respectively engaged to the two first engaging portions S21, S21a when the two extending arms 132, 132a are in the engaging position A1. When the two extending arms 132, 132a are in the releasing position A2, the two second engaging portions 1321, 1321a abut against the two first engaging portions S21, S21a, so that the two first engaging portions S21, S21a are relatively far apart, and the second engaging portions 1321, 1321a can respectively abut against and release the latch with the first engaging portions S21, S21a.

As shown in FIGS. 3A and 3B, the elastic member insertion hole 1327 of the slider 13 is used to insert the elastic member 12 into the first limiting slot 115, so that the elastic member 12 is located between the first limiting surface 1151 and the first limiting portion 1323. When the slider 13, the body 11, and the elastic members 12, 12a of the pluggable optical transceiver module 10 are assembled, the extending arms 132, 132a of the slider 13 are first respectively mounted on the two sliding slots 114, 114a of the body 11, and then the elastic member 12 is placed into the first limiting slot 115 through the elastic member insertion hole 1327. The length of the elastic member insertion hole 1327 is, for example, smaller than that of the elastic member 12, and the user can first compress the elastic member 12 to shorten its length before inserting it through the elastic member insertion hole 1327. After being placed in the first limiting slot 115, the elastic member 12 can be restored to its original length through the elasticity and is located between the first limiting surface 1151 and the first limiting portion 1323. The present embodiment is described only by the assembly of the elastic member 12, and the assembly process of the elastic member 12a is similar thereto, and no redundant detail is to be given herein. The slider 13, the body 11, and the elastic member 12 can be easily and accurately assembled into the pluggable optical transceiver module 10 through the arrangement of the elastic member insertion holes 1327.

Further, the present embodiment is exemplified by that the pluggable optical transceiver module 10 includes two elastic members 12, 12a, the body 11 includes two first limiting slots 115, 115a, and the two elastic members 12, 12a are respectively disposed in the two first limiting slots 115, 115a; however, the invention is not limited thereto. In other embodiments of the present invention, the pluggable optical transceiver module may include only one elastic member and the body may include only one first limiting slot as long as the slider 13 can be moved to the engaging position A1 by the restoring force of the elastic member while the handle 15 is not pulled.

In detail, the body 11 further includes two second limiting slots 116, 116a. The two second limiting slots 116, 116a are respectively disposed in the two sliding slots 114, 114a. The second limiting slot 116 is adjacent to the end point of the sliding slot 114 on the side of the head portion 111. The extending arm 132 further includes a second limiting portion 1325, and the elastic member insertion hole 1327 is located between the first limiting portion 1323 and the second limiting portion 1325. As shown in FIGS. 3B and 3C, the second limiting portion 1325 is moved in the second limiting slot 116 when the slider 13 is disposed on the body 11. The present embodiment is described in detail only by the second limiting portion 1325 of the extending arm 132. The structure of the second limiting portion 1325a of the extending arm 132a is similar to that of the second limiting portion 1325 of the extending arm 132, and no redundant detail is to be given herein. Through the arrangement of the second limiting slots 116, 116a and the second limiting portions 1325, 1325a, the slider 13 can be moved relative to the body 11 between the engaging position A1 and the releasing position A2, and without separating the slider 13 from the body 11 by pulling the handle 15.

Referring to FIG. 4B, specifically, the second limiting slot 116 includes a third limiting surface 1161 and a fourth limiting surface 1163, and the third limiting surface 1161 is closer to the end point of the head portion 111 away from the insertion portion 113 than the fourth limiting surface 1163. The second limiting portion 1325 of the extending arm 132 is moved relative to the extending arm 132 between the coupling position B1 and the separating position B2. The second limiting portion 1325 is located at the coupling position B1 when the second limiting portion 1325 is not affected by the external force F2. The second limiting portion 1325 is moved toward the outside of the slider 13 to the separating position B2 when the second limiting portion 1325 is pushed by the external force F2.

The second limiting portion 1325 is moved between the third limiting surface 1161 and the fourth limiting surface 1163 of the second limiting slot 116 when the slider 13 is disposed on the body 11 and the second limiting portion 1325 is located at the coupling position B1. At this time, the second limiting portion 1325 is blocked by the third limiting surface 1161 so that the second limiting portion 1325 cannot be separated from the second limiting slot 116. Therefore, the slider 13 can be moved relative to the body 11 between the engaging position A1 and the releasing position A2 without separating the slider 13 from the body 11 by pulling the handle 15. When the second limiting portion 1325 is pushed by the external force F2 to move toward the outside of the slider 13 to the separating position B2, the second limiting portion 1325 is not blocked by the third limiting surface 1161, so that the second limiting portion 1325 can be separated from the second limiting slot 116 and the slider 13 can be separated from the body 11. As such, the slider 13 can be detached from the body 11 to, for example, replace the damaged slider 13.

As shown in FIG. 3A, in detail, the body 11 of the pluggable optical transceiver module 10 further includes two detaching holes 1165, 1165a, a first end surface 1111, and a second end surface 1131. The first end surface 1111 is opposite to the second end surface 1131, the two side surfaces 112, 112a are respectively connected to the first end surface 1111 and the second end surface 1131, the first end surface 1111 is located at one end side of the head portion 111, and the second end surface 1131 is located at one end side of the insertion portion 113. The detaching hole 1165 penetrates from the first end surface 1111 to the third limiting surface 1161 of the second limiting slot 116 for the detaching member 16 to penetrate the detaching hole 1165 and give the second limiting portion 1325 an external force F2. Therefore, by the arrangement of the detaching hole 1165, when the slider 13 is disposed on the body 11, the user can use the detaching member 16 having an elongated rod-like structure to penetrate the detaching hole 1165 to give the second limiting portion 1325 an external force F2, so that the slider 13 can be detached from the body 11. The effect and function of the detaching hole 1165a are similar to those of the detaching hole 1165, and no redundant detail is to be given herein. The external force F2 given to the second limiting portion 1325 by providing the detaching hole 1165 is only one possible embodiment of the present invention. The present invention may give the second limiting portion 1325 an external force F2 by other means.

In the present embodiment, the second engaging portions 1321, 1321a of the extending arm 132 may be, for example, a structure in which the extending arm 132 extends toward the outside of the slider 13, but the invention is not limited thereto. The first limiting portion 1323, 1323a of the extending arm 132 may be, for example, a structure in which the extending arm 132 extends toward the inner side of the slider 13, but the invention is not limited thereto. The second limiting portion 1325, 1325a of the extending arm 132 may be, for example, a structure in which the extending arm 132 extends toward the inner side of the slider 13, but the invention is not limited thereto. The structure and form of the second engaging portions 1321, 1321a, the first limiting portions 1323, 1323a, and the second limiting portions 1325, 1325a of the extending arm 132 shown in FIGS. 1A to 4B are merely illustrative and not used to limit the invention.

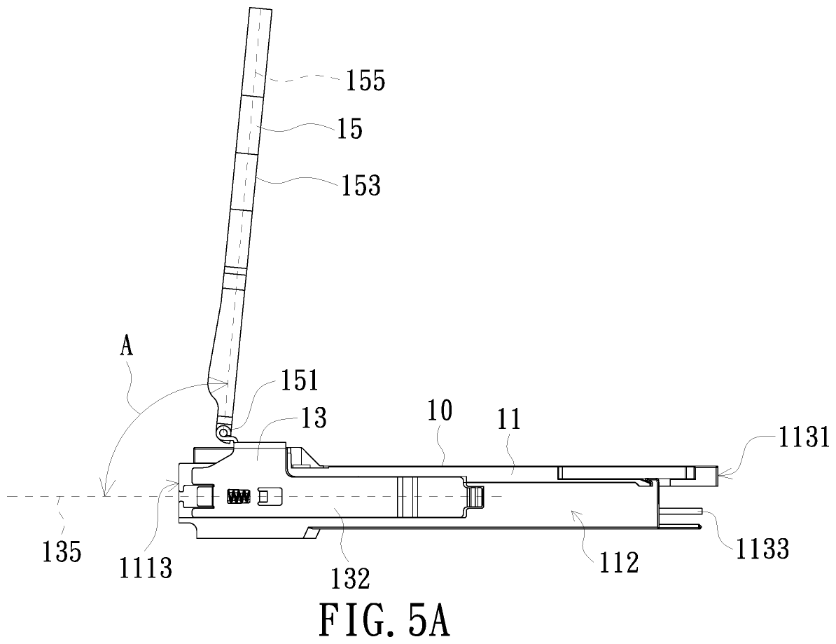

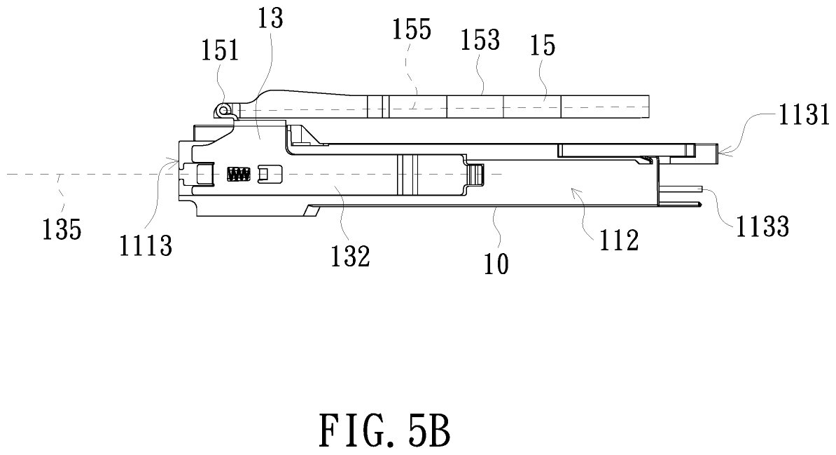

As shown in FIG. 3A, specifically, the handle 15 is pivotally mounted to the connecting arm 131 of the slider 13. In detail, the handle 15 is pivotally mounted to the connecting arm 131 via a pivot 151. Please also refer to FIG. 5. FIG. 5 is a schematic view of the operation of the handle 15 of the pluggable optical transceiver module 10. The handle 15 is rotatable relative to the slider 13 by the pivot 151 to expose the optical interface 1113 of the body 11. As such, the user can more easily connect a component such as a fiber optic cable to the optical interface 1113. The angle A of the rotation of the handle 15 with respect to the slider 13 can be, for example, between 0-180 degrees.

In detail, the handle 15 includes a handle body 153. The handle body 153 includes a long axis 155. The long axis 155 is, for example, on a line segment from the end point of the handle body 153 away from the pivot 151 to the end point adjacent to the pivot 151. The two extending arms 132, 132a respectively move in the two sliding slots 114, 114a along a moving axis 135 when the slider 13 is disposed on the body 11. The angle between the long axis 155 and the moving axis 135 is between 0-180 degrees when the handle 15 is rotated relative to the slider 13. The position of the pivot 151 may be, for example, above the body 11 of the pluggable optical transceiver module 10, or the position of the pivot 151 may be above the connecting arm 131 of the slider 13. Therefore, the angle between the long axis 155 and the moving axis 135 may be between 0-180 degrees when the handle 15 is rotated relative to the slider 13. Therefore, when the angle between the long axis 155 of the handle 15 and the moving axis 135 is, for example, about 90 degrees (as shown in FIG. 5A), the optical interface 1113 of the body 11 can be exposed, so that the user can more conveniently connect an element such as an optical fiber cable to the optical interface 1113. When the angle between the long axis 155 of the handle 15 and the moving axis 135 is about 180 degrees (as shown in FIG. 5B), the overall length and volume of the pluggable optical transceiver module 10 can be reduced, for example, for convenient storage.

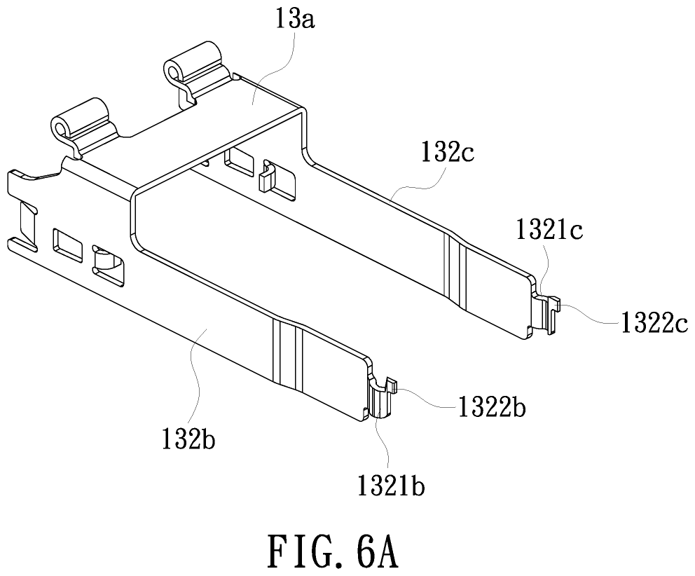

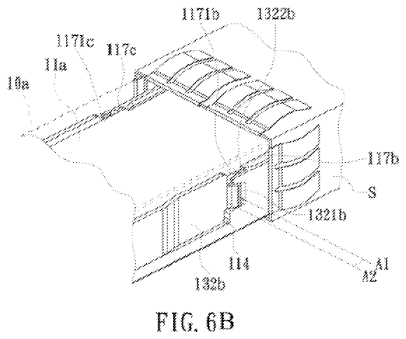

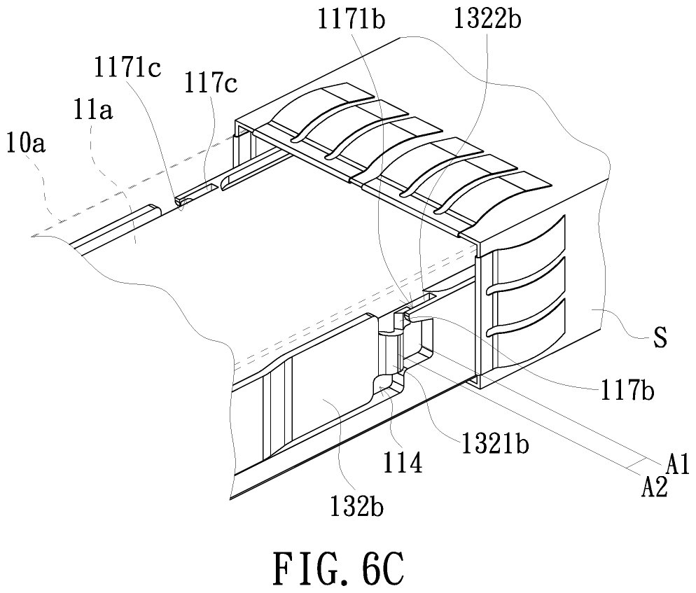

Referring to FIGS. 6A to 6C. FIG. 6A is a schematic view of a slider 13a of a pluggable optical transceiver module 10a according to another embodiment of the present invention, and FIGS. 6B and 6C are partial schematic views of the pluggable optical transceiver module, 10a partially inserted into the socket S according to another embodiment of the present invention. The pluggable optical transceiver module 10a of the present embodiment includes a body 11a and a slider 13a. The pluggable optical transceiver module 10a of the present embodiment has a similar structure and function to the pluggable optical transceiver module 10 shown in FIGS. 1A to 5B. The difference between the present embodiment and the embodiment shown in FIGS. 1A to 5B mainly lies in that the extending arms 132b, 132c of the slider 13a further include latching members 1322b, 1322c, and the latching members 1322b, 1322c are respectively connected to the second engaging portions 1321b, 1321c (as shown in FIG. 6A). As shown in FIGS. 6B and 6C, the body 11a further includes latching slot holes 117b, 117c, and the latching slot holes 117b, 117c respectively correspond to the latching members 1322b, 1322c. For convenience of explanation of the latching slot holes 117b, 117c, the upper portion of the body 11a in FIGS. 6B and 6C is presented in a see-through manner. The structure and function of the body 11a, the slider 13a, the extending arms 132b, 132c, the second engaging portions 1321b, 1321c of the present embodiment and the structure and function of the body 11, the slider 13, the extending arms 132, 132a, and the second engaging portions 1321, 1321a shown in FIGS. 1A to 5B tare substantially the same, and no redundant detail is to be given herein.

As shown in FIG. 6B, the latching member 1322b is located in the corresponding latching slot hole 117b when the extending arm 132b is located at the engaging position A1 (i.e., the handle of the pluggable optical transceiver module 10a is not pulled). Since the latching member 1322b is located in the latching slot hole 117b, the extending arm 132b of the slider 13a is restricted by the latching slot hole 117b of the body 11a and does not expand toward the outside of the pluggable optical transceiver module 10a. When the slider 13a is disposed on the body 11a, the extending arms 132b, 132c are likely to expand toward the outside of the pluggable optical transceiver module 10a due to the material characteristics of the slider 13a. As shown in FIG. 6B, in the process of inserting the optical transceiver module 10a into the socket S, the pluggable optical transceiver module 10a and/or the socket S may be damaged if the extending arms 132b and 132c are expanded outward. The pluggable optical transceiver module 10a of the present embodiment can effectively prevent the extending arms 132b, 132c from expanding outward by the arrangement of the latching members 1322b, 1322c and the latching slot holes 117b, 117c. The structure and function of the latching member 1322c and the latching slot hole 117c are substantially the same as those of the latching member 1322b and the latching slot hole 117b, and no redundant detail is to be given herein.

Further, as shown in FIG. 6C, the latching member 1322b is still located in the latching slot hole 117b when the extending arm 132b is in the releasing position A2 (i.e., the handle of the pluggable optical transceiver module 10a is pulled); however, the invention is not limited thereto. That is, the latching member 1322b may move in the latching slot hole 117b when the extending arm 132b is moved between the engaging position A1 and the releasing position A2. Therefore, the extending arms 132b, 132c can be prevented from expanding outward when the slider 13a moves between the engaging position A1 and the releasing position A2.

In detail, the latching slot hole 117b may include an latching surface 1171b. The latching surface 1171b faces the inner side of the body 11a. The latching member 1322b is adjacent to the latching surface 1171b when the latching member 1322b is located in the latching slot hole 117b, so that the extending arm 132b can be prevented from expanding outward. The latching member 1322b may be close to, fit to or abutting against the latching surface 1171b, and the invention is not limited thereto; as long as the latching slot hole 117b can include a structure that can contact with the latching member 1322b so that the extending arm 132b can be prevented from expanding toward the outside of the pluggable optical transceiver module 10a. The latching surface 1171c included in the latching slot hole 117c has a structure and function similar to that of the latching surface 1171b. The structure and form of the latching members 1322b, 1322c and the latching slot holes 117b, 117c shown in FIGS. 6A to 6C are merely illustrative and are not intended to limit the invention.

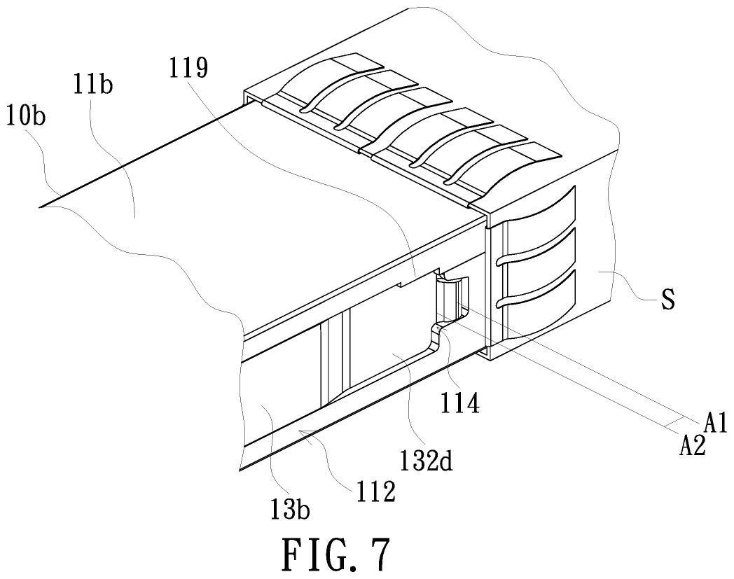

Please refer to FIG. 7. FIG. 7 is a partial schematic view of the pluggable optical transceiver module 10b partially inserted into the socket S according to another embodiment of the present invention. The pluggable optical transceiver module 10b of the present embodiment includes a body 11b and a slider 13b. The pluggable optical transceiver module 10b of the present embodiment has a similar structure and function to the pluggable optical transceiver module 10 shown in FIGS. 1A to 5B. The main difference between the present embodiment and the embodiment shown in FIGS. 1A to 5B lies in that the body 11b further includes an extension structure 119. The extension structure 119 extends from the side surface 112 of the body 11b to the inside of the body 11b, and the extension structure 119 extends from the outside of the sliding slot 114 to the inside of the sliding slot 114.

When the extending arm 132d of the slider 13b is at the engaging position A1, the extension structure 119 of the body 11b shields part of the extending arm 132d so that the partial extending arm 132d is not exposed to the outside of the body 11b. The body 11b, the slider 13b, and the extending arm 132d of the present embodiment are substantially the same in structure and function as the body 11, the slider 13, and the extending arm 132 shown in FIGS. 1A to 5B, and no redundant detail is to be given herein.

When the extending arm 132d is in the engaging position A1 (i.e., the handle of the pluggable optical transceiver module 10b is not pulled), the extension structure 119 of the body 11b can shield part of the extending arm 132d so that the partial extending arm 132d is not exposed to outside the body 11b. Therefore, the extending arm 132d of the slider 13b is blocked by the extension structure 119 of the body 11b and does not expand toward the outside of the pluggable optical transceiver module 10b, thereby effectively preventing the extending arm 132d from expanding outward to cause the problem of damage to the pluggable optical transceiver module 10b and/or the socket S.

Further, when the extending arm 132d is in the releasing position A2 (i.e., the handle of the pluggable optical transceiver module 10b is pulled), the extension structure 119 of the body 11b can also shield the part of the extending arm 132d so that the partial extending arm 132d is not exposed to the outside of the body 11b, but the invention is not limited thereto. That is, when the extending arm 132d moves between the engaging position A1 and the releasing position A2, a part of the extending arm 132d is blocked by the extension structure 119 without being exposed to the outside of the body 11b. Therefore, the extending arm 132d can be prevented from expanding outward when the slider 13b moves between the engaging position A1 and the releasing position A2. The present embodiment is exemplified only by the extending arm 132d of the slider 13b, and the body 11b may also include a similar extension structure (not shown) at the other extending arm (not shown) of the slider 13b, and no redundant detail is to be given herein.

It should be noted that the position, structure and form of the extension structure 119 of the body 11b shown in FIG. 7 are merely illustrative and are not intended to limit the invention; as long as when the extending arm 132d of the slider 13b is at the engaging position A1, the extension structure can shield part of the extending arm 132d so that the part of the extending arm 132d is not exposed to the outside of the body 11b.

In summary, the pluggable optical transceiver module of the embodiment of the present invention includes a slider that can be easily and quickly disassembled and assembled. When the slider and/or the handle are damaged, it can be replaced quickly and easily. The handle of the optical transceiver module of the present invention can be pivoted relative to the body between 0-180 degrees, so that components such as fiber optic lines can be easily connected with the optical transceiver module, and the optical transceiver module can be conveniently stored.

Although the present invention has been disclosed in the above embodiments, it is not intended to limit the present invention, and those skilled in the art can make some modifications and refinements without departing from the spirit and scope of the present invention. Therefore, the scope of the invention is defined by the scope of the appended claims.

The present disclosure effectively overcomes various disadvantages in the prior arts and hence has high industrial usage value. The foregoing embodiments only illustrate the principle and efficacy of the present disclosure exemplarily, and are not meant to limit variations of the technique. Any person skilled in the art can make modifications on the foregoing embodiments without departing from the spirit and scope of the present disclosure. Accordingly, all equivalent modifications or variations completed by those with ordinary skill in the art without departing from the spirit and technical thinking disclosed by the present disclosure should fall within the scope of claims of the present disclosure.

1. What is claimed is A pluggable optical transceiver module for being inserted into a slot of a socket, comprising:
two first engaging portions located in the slot;
a body having a first end surface and a second end surface, wherein the first end surface is opposite to the second end surface, wherein an optical interface is disposed at the first end surface and an electrical interface is disposed at the second end surface, for converting optical signals to electrical signals, wherein the body further comprises a head portion, an insertion portion at the other end, two side surfaces, two sliding slots, and at least one first limiting slot,
wherein the insertion portion is for being inserted into the slot of the socket, wherein the head portion is connected to the insertion portion, wherein the two side surfaces are opposite to each other, wherein the two side surfaces are respectively located on opposite sides of the head portion and wherein the insertion portion and the two sliding slots are respectively disposed on the two side surfaces, the first limiting slot is disposed in one of the sliding slots, wherein the at least first limiting slot comprises a first limiting surface and a second limiting surface, and wherein the first limiting surface is closer to an end point of the head portion away from the insertion portion than the second limiting surface;
a slider, detachably disposed on the body, wherein the slider comprises a connecting arm and two extending arms, wherein the connecting arm is connected between the two extending arms, and each of the extending arms comprises a second engaging portion, a first limiting portion, and an elastic member insertion hole; and
at least one elastic member, wherein when the slider is disposed on the body, the body is located between the two extending arms, the two extending arms respectively move in the two sliding slots, and the first limiting portion moves in the first limiting slot, the elastic member is disposed in the first limiting slot, and the elastic member is located between the first limiting surface and the first limiting portion of the slider, wherein the elastic member insertion hole is for inserting the elastic member into the first limiting slot, so that the elastic member is located between the first limiting surface and the first limiting portion.

2. The pluggable optical transceiver module according to claim 1, wherein when the slider is disposed on the body and the body is inserted into the slot, each of the extending arms is moved between an engaging portion and a releasing position in each of the sliding slots, wherein when the two extending arms are in an engaging position, the two second engaging portions are engaged on the two first engaging portions, wherein when the two extending arms are in the releasing position, the two second engaging portions push against the two first engaging portions, so that the two first engaging portions are relatively far apart.

3. The pluggable optical transceiver module according to claim 2, wherein one of the two extending arms further comprises a latching member, wherein the latching member is connected to the second engaging portion, wherein the body further comprises a latching slot hole, wherein the latching slot hole corresponds to the latching member, and the latching member is located in the latching slot hole when said extending arm is in the engaging position.

4. The pluggable optical transceiver module according to claim 3, wherein the latching slot hole comprises a latching surface, the latching surface faces an inner side of the body, and the latching member is adjacent to the latching surface when the latching member is located in the latching slot hole.

5. The pluggable optical transceiver module according to claim 2, wherein the body further comprises an extension structure, wherein the extension structure extends from the side surface to an inside of the body, the extension structure further extends from an outside of the sliding slot to an inside of the sliding slot, and the extension structure partially shields the extending arm when the extending arm is in the engaging position, such that a portion of the extending arm is not exposed to the body.

6. The pluggable optical transceiver module according to claim 1, wherein the pluggable optical transceiver module further comprises two elastic members, wherein the body further comprises the two first limiting slots, wherein the two first limiting slots are respectively disposed in the two sliding slots, and wherein the two elastic members are respectively disposed in the two first limiting slots when the slider is disposed on the body.

7. The pluggable optical transceiver module according to claim 1, wherein the body further comprises two second limiting slots, the two second limiting slots are respectively disposed in the two sliding slots, the second limiting slot is adjacent to an end point of the sliding slot on a side of the head portion, each of the two extending arms further comprises a second limiting portion, and the elastic member insertion hole is located between the first limiting portion and the second limiting portion; wherein the second limiting portion moves in the second limiting slot when the slider is disposed on the body.

8. The pluggable optical transceiver module according to claim 7, wherein the second limiting slot comprises a third limiting surface and a fourth limiting surface, and the third limiting surface is closer to an end point of the head portion away from the insertion portion than the fourth limiting surface; wherein the second limiting portion moves relative to the two extending arms between a coupling position and a separating position, the second limiting portion is located at the coupling position when the second limiting portion is not affected by an external force, and wherein the second limiting portion is pushed by the external force to move toward an outside of the slider to the separating position; when the slider is disposed on the body and the second limiting portion is in the coupling position, the second limiting portion is moved between the third limiting surface and the fourth limiting surface of the second limiting slot, and the second limiting portion is blocked by the third limiting surface, so that the second limiting portion cannot be separated from the second limiting slot; and
when the second limiting portion is pushed by the external force to move toward an outside of the slider to the separating position, the second limiting portion is not blocked by the third limiting surface, so that the second limiting portion can be separated from the second limiting slot and the slider is separated from the body.

9. The pluggable optical transceiver module according to claim 1, wherein the body further comprises two detaching holes, wherein the two side surfaces are respectively connected to the first end surface and the second end surface, wherein the first end surface is located at one end side of the head portion wherein an optical fiber cable is connected to the optical interface to provide light into the optical transceiver module, the second end surface is located at one end side of the insertion portion wherein the electrical interface is connected to the slot, wherein the detaching hole penetrates from the first end surface to the third limiting surface, so that a detaching member penetrates the detaching hole to give the external force to the second limiting portion.

10. The pluggable optical transceiver module according to claim 1, further comprising a handle pivotally disposed on the connecting arm of the slider.

11. The pluggable optical transceiver module according to claim 10, wherein the handle comprises a handle body, wherein the handle body comprises a long axis, wherein the two extending arms respectively move into the two sliding slots along a moving axis when the slider is disposed on the body, and wherein an angle between the long axis and the moving axis is between 0 and 180 degrees when the handle rotates relative to the slider.
